(19) United States
(12) Patent Application Publication
(10) Pub. No.: US 2015/0321919 A1
(43) Pub. Date: Nov. 12, 2015

(54) SYSTEM AND METHOD FOR PRODUCING CARBON NANOFIBERS VIA RADIO-FREQUENCY INDUCTION HEATING

(71) Applicant: Solarno, Inc., Coppell, TX (US)

(72) Inventor: Lissa King Magel, Coppell, TX (US)

(21) Appl. No.: 14/706,682

(22) Filed: May 7, 2015

Related U.S. Application Data
(60) Provisional application No. 61/989,826, filed on May 7, 2014.

(51) Int. Cl. C01B 31/02; D01F 9/16; H05B 6/10; D01F 9/21; D01F 9/24; D01F 9/32; D01F 9/14; D01F 9/17

(52) U.S. Cl. CPC C01B 31/0293; D01F 9/14; D01F 9/16; D01F 9/17; D01F 9/21; D01F 9/24; D01F 9/324; D01F 9/328; H05B 6/105

(57) ABSTRACT

An apparatus and method for carbonizing or activating carbon nanofibers, or both carbonizing and activating carbon nanofibers, using separate heating of nanofibers and process gases for increased sample temperature response to reduce production costs and improve process control. In one embodiment, the system includes a reactor tube into which a selected atmosphere can be introduced and which is closed at the ends by flanges. Samples are placed inside the tube on or in a susceptor, which is heated by RF induction via RF coils surrounding the reactor tube, and process gases, which can be independently heated, flow through the tube.

### CROSS-REFERENCE TO RELATED APPLICATION

This application claims the benefit of U.S. Provisional Application Ser. No. 61/989,826, filed by Magel on May 7, 2014, entitled “System to Produce Carbon Nanofibers Via RF Induction Heating,” commonly assigned with this application and incorporated herein by reference.

### STATEMENT REGARDING FEDERALLY SPONSORED RESEARCH OR DEVELOPMENT

This invention was made with Government support under award NSF STIR IIP-1127564 awarded by the National Science Foundation to Solarno, Incorporated.

### TECHNICAL FIELD

This application is directed, in general, to the production of carbon nanomaterials. More specifically, this application relates to a method for carbonizing carbon nanofiber precursors, activating carbon nanofibers, or both, using radio-frequency (RF) induction heating.

### BACKGROUND

The tremendous growth in the numbers of portable electronic devices and hybrid electric vehicles and the need to integrate intermittent renewable energy resources into the electrical grid has touched off an urgent demand for higher performance electrical energy storage devices.

“Supercapacitors,” also known as electrochemical double layer capacitors (EDLCs), are energy storage devices that have high charge and discharge rates (high power densities), and long cycle life, but have lower energy densities compared to batteries (see, e.g., Pandolfo, et al., “Carbon properties and their role in supercapacitors,” J. Power Sources 2006, 157, 11-27). Supercapacitors store energy via a charge separation between its electrode and oppositely charged electrolyte ions at the electrode/electrolyte interface when the electrodes are charged. Capacitance, and thus energy density, is much higher than for conventional capacitors because the distance across the electrical double layer between the electrode and the electrolyte is approximately the size of the solvated ion radius (≦5 nm). Capacitance is further enhanced by using an electrode material with high specific surface area.

Since the concept was first patented (U.S. Pat. No. 2,800,616 issued to Becker on Jul. 23, 1957 and titled “Low voltage electrolytic capacitor”) a multitude of materials with various components and structures have been tested as supercapacitor electrodes, but carbon materials have attracted the most interest due to their low cost and variety of available forms such as powders, granules, fibers, nanotubes, nanocomposites, etc. Today most commercial supercapacitors use electrodes made from activated carbon to obtain the required high surface area. In order to further enhance energy and power density, researchers have put much effort into tailoring electrode porosity by controlling pore size distribution during activation while simultaneously maximizing electrolyte access and the conductivity of the electrode. In particular, carbon nanofibers feature intrinsically high surface area, which is easily accessible to electrolyte ions, and have been extensively investigated for application as supercapacitor electrode materials. Nanofiber surface area can be further increased by physical activation to form pores, with the final pore size distribution dependent on process temperature and time.

One means of producing carbon nanofibers is by carbonizing electrospun polymer nanofibers. Electrospinning is a flexible, scalable technique in which a precursor solution is injected through a charged needle (10-20 kV) to extrude fibers onto a grounded collector. There are many possible choices of fiber precursors, ranging from polymer solutions to particulate suspensions to melts, depending on what final structure and properties are desired for the carbon nanofibers after carbonization and activation.

To produce carbon nanofibers, electrospun polymer nanofibers are typically carbonized and activated in a batch process in a furnace at temperatures between 700 and 1100° C. under a controlled atmosphere (an inert gas such as He, N₂, Ar, or mixtures thereof or vacuum for carbonization with the addition of CO₂, O₂, steam, or air for activation). The resulting non-woven mat of carbon nanofibers is self-supporting and does not require a binder for use as a supercapacitor electrode. Alternatively, the carbon nanofibers can be milled, ground, chopped, or otherwise reduced in size and mixed with a binder and possibly a conductivity enhancer to form a slurry or paste that can be adhered to a current collector for use as a supercapacitor electrode.

A major disadvantage of the conventional process is that the large thermal mass of conventional furnaces limits the rate at which the nanofibers can be heated and cooled (5-10° C./min), so the entire process sequence takes hours longer (7-8 hours total) than the ˜1 hour required to accomplish the carbonization and activation of the nanofibers. This is expensive in terms of both time and the cost of energy to heat the furnace. In addition, since carbonization can be considered to be happening at temperatures above around 700° C., when a nominal 1000° C./1 hour carbonization is desired, the slow heating and cooling rate of a conventional furnace means that the sample is actually carbonized for 1-2 hours more than the desired 1-hour treatment. This limits control of process parameters, sets the minimum carbonization time to a rather large value, and adds error the measurement of the actual carbonization time. Similarly, the activation process requires that an etchant gas such as CO₂, air, or steam be added to the inert carrier gas in the furnace tube. When the desired activation time is complete the flow of the etchant gas is stopped, but some etchant will remain in the furnace tube until it is flushed out by the flow of the carrier gas. Thus the etching process will continue until either the etchant gas is flushed out or the sample temperature decreases below 700-800° C. Since it takes 20-30 minutes for a conventional furnace to cool from 1000° C. to 700-800° C. an unknown error is added to the measurement of the actual activation time, resulting in a poorly controlled process.

### SUMMARY

One aspect provides an apparatus for carbonizing or activating carbon nanofibers, or both carbonizing and activating carbon nanofibers. In one embodiment, the apparatus includes: (1) a reactor tube into which a selected atmosphere can be introduced and that is closed at ends thereof, (2) a susceptor inside the reactor tube and configured to receive at least one sample and (3) at least one radio-frequency coil proximate the reactor tube configured to heat the susceptor.

Another aspect provides a method of carbonizing or activating carbon nanofibers, or both carbonizing and activating carbon nanofibers. In one embodiment, the method includes: (1) introducing a selected atmosphere into a reactor tube that is closed at ends thereof, (2) receiving a sample on or in a susceptor inside the reactor tube and (3) heating the susceptor with at least one radio-frequency coil proximate the reactor tube.

### BRIEF DESCRIPTION

Reference is now made to the following descriptions taken in conjunction with the accompanying drawings, in which:

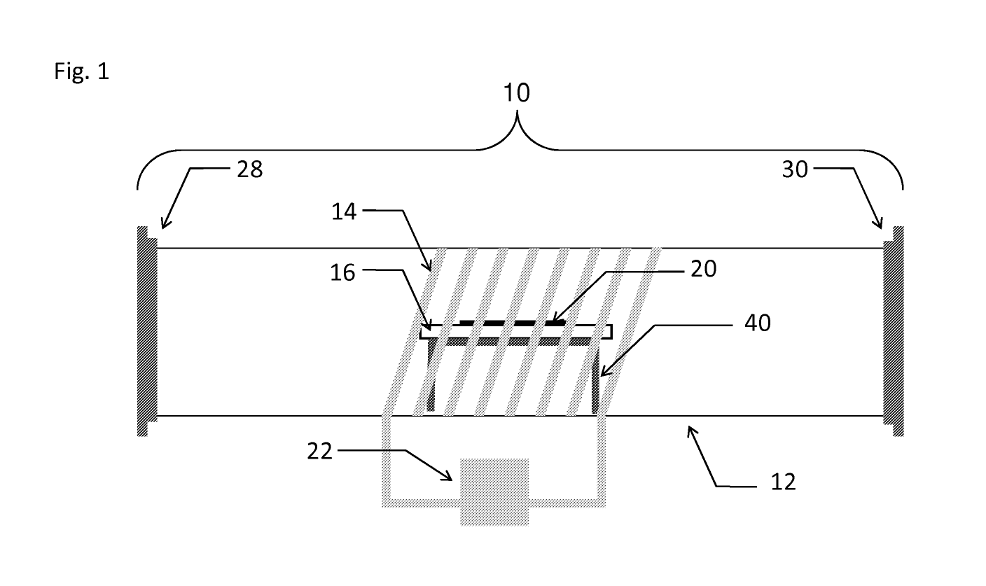

FIG. 1 depicts one embodiment of the present invention where a planar susceptor is installed in a quartz tube;

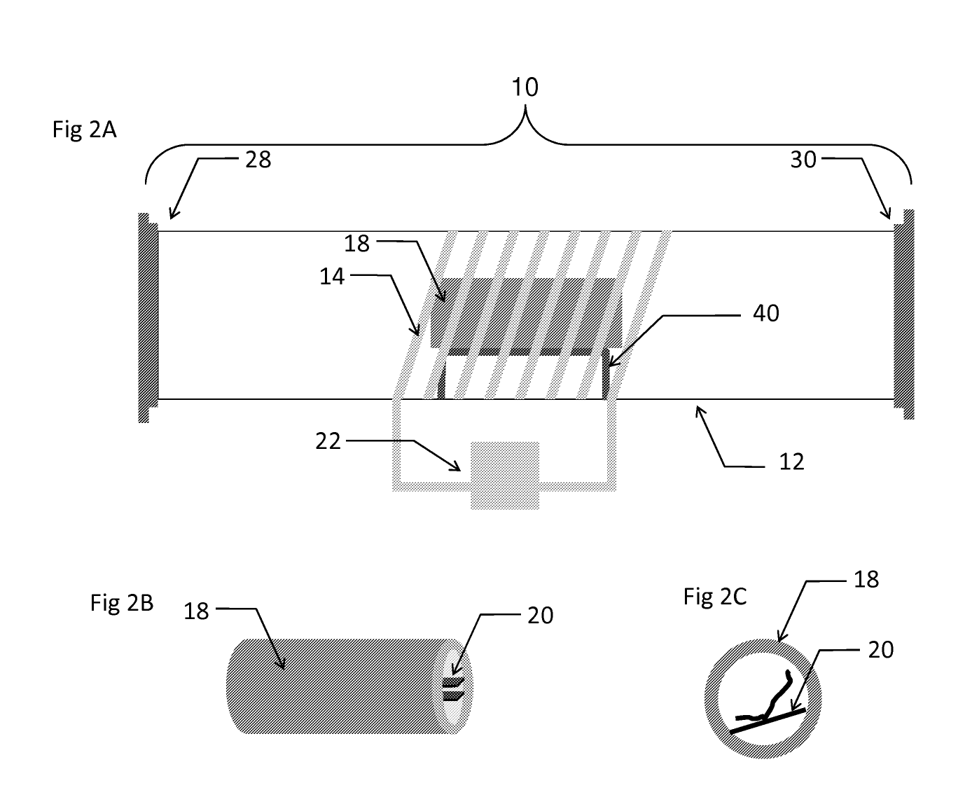

FIGS. 2A, 2B, and 2C depict a 2^{nd} embodiment of the present invention where a hollow cylindrical susceptor is installed in a quartz tube;

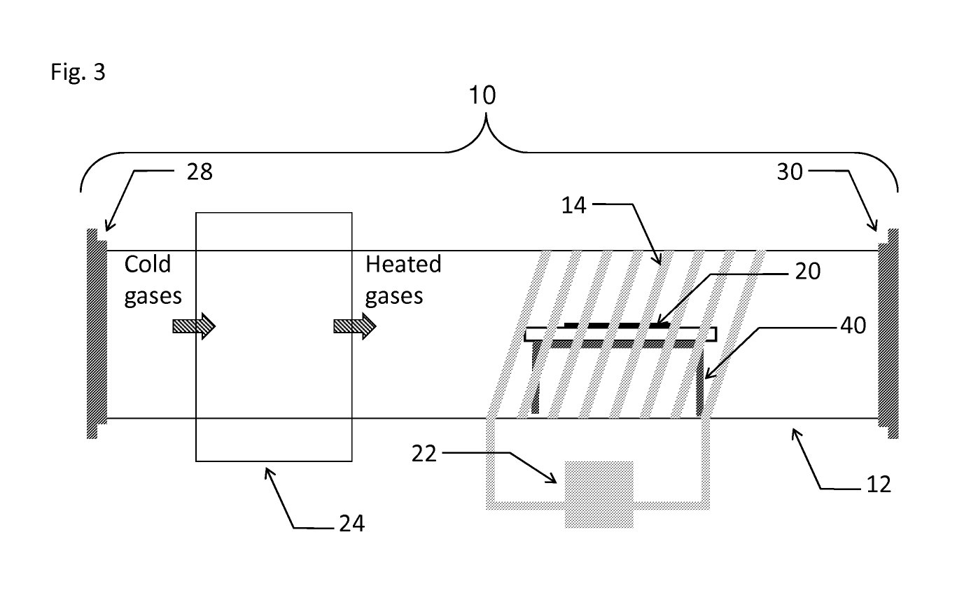

FIG. 3 depicts another embodiment the present invention with conventional furnace elements in addition to a susceptor;

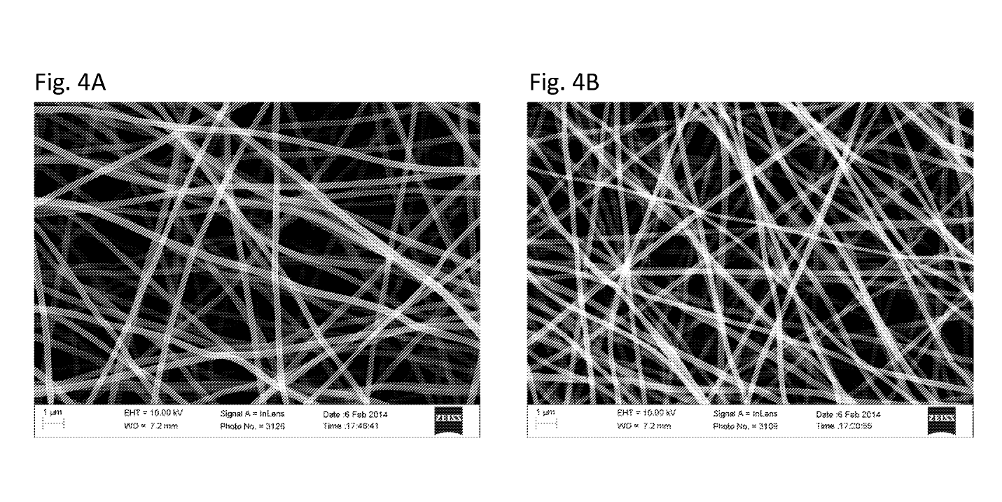

FIGS. 4A and 4B are SEM photographs of nanofiber mats carbonized and activated in a conventional tube furnace and carbonized using RF induction heating, respectively; and

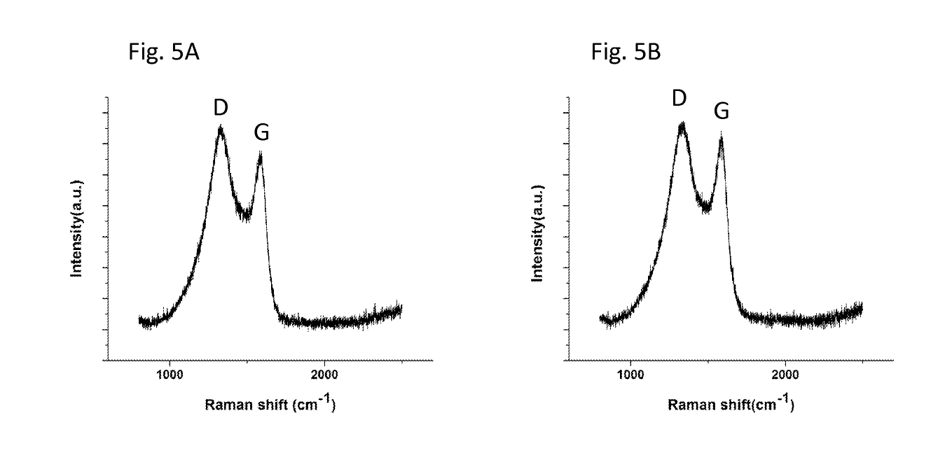

FIGS. 5A and 5B show Raman spectra of nanofibers carbonized in conventional tube furnace compared with nanofibers carbonized using RF induction heating, respectively.

### DETAILED DESCRIPTION

As stated above, a major disadvantage of the conventional carbon nanofiber production process is that the large thermal mass of conventional furnaces limits the rate at which the nanofibers can be heated and cooled. Another disadvantage is that the process is difficult to control.

It is realized herein that a need exists for a novel apparatus and method for manufacturing activated carbon nanofibers that reduces costs associated with their production and allows, in one application, widespread commercial use of supercapacitors that use electrodes incorporating carbon nanofibers.

Accordingly, introduced herein are various embodiments of an apparatus and method for producing carbonized or activated carbon nanofibers, or both carbonized and activated carbon nanofibers, using RF induction heating while controlling the flow of any gases that may flow into and out of the chamber.

In one embodiment, an apparatus for heat-treating carbon nanofiber precursors includes a reactor tube capped at each end by flanges. The heat treatment takes place inside the volume defined by the tube and flanges. The flanges also provide means for entry and exit of carrier and reactant gases and effluent species. The tube is surrounded by an RF induction coil, which, when energized, inductively couples to a susceptor positioned within the tube. Material to be heat-treated is positioned upon or within the susceptor and is heated by conduction and radiation from the susceptor and convection from gases heated by the susceptor. The elements of the embodiment and the benefits to be derived therefrom and from other aspects and embodiments disclosed herein will be more readily apparent after the following description taken in connection with the accompanying drawings.

Use of a susceptor to heat and support the nanofiber material allows a faster response of the heating element so that the nanofibers can be heated from room temperature to 1000° C. for carbonization or activation in 2-5 minutes, compared to >3 hours with a conventional tube furnace. It is possible to combine carbonization and activation in a single step at the same temperature by adding an etchant gas to the inert gas used for carbonization. Alternatively, the samples can be carbonized at one temperature with an inert gas for a set time after which the susceptor temperature can be quickly raised or lowered and an etchant gas can be added to activate the sample. This process would not be feasible on such short time scales with a conventional furnace. At the end of the process, the lower thermal mass allows a system using RF heating to cool more quickly, terminating carbonization/activation processes and reducing the error in measuring the process time. This system also cools to room temperature in 30-40 minutes for sample unloading compared to 4 hours for the furnace, significantly improving cycle time. Another embodiment involves separately heating the process gases to one temperature in a pre-heating chamber and controlling the temperature of the sample on the susceptor to a different temperature using RF heating.

The examples discussed below are primarily focused on the use of polyacrylonitrile (PAN) as the precursor material, but the system may also be used with many other nanofiber precursor materials including, for example: polybenzimidazole (PBI), polyimide (PI), regenerated cellulose fiber (e.g., Rayon®), phenol resin, cellulose, lignin, and lignin-base/blended precursors. Many of these nanofiber precursors will typically require an oxidative stabilization pretreatment to be useful as feedstock for carbonization/activation.

In the following, an apparatus specifically adapted for the carbonization and/or activation of carbon nanofibers will be described for purposes of illustration, but the invention is not to be construed as so limited. Referring now to the invention in more detail, FIG. 1 schematically depicts in cross-section a heating system 10 in accordance with the invention. The apparatus includes a reactor tube 12, which is closed at the ends by flanges 28 and 30. Tube 12 is a conventional furnace/reactor tube of quartz or similar material. The flanges are of stainless steel attached to the ends of the tube in a conventional manner.

The apparatus as so far described is similar to the conventional tube furnace for heat treatment. In that conventional tube furnace, samples such as polymer nanofiber mats would be placed on a sample support and positioned within the furnace where they are heated through convection and IR radiation from furnace elements surrounding the tube. The speed at which the samples can be heated and cooled is severely restricted because of the large thermal mass of the furnace. The heating/cooling rate problem is overcome in accordance with the present invention through the use of an RF induction-heating coil 14, which surrounds the reactor tube in conjunction with a susceptor 16 that supports the sample 20 in the reactor tube. The induction coil is connected to an RF generator (22), which is capable of supplying RF energy for heating.

The susceptor comprises, for example, a plate of graphite, and is positioned approximately along the axis of tube 12 and is maintained in that position by a support 40. RF energy supplied to the induction heating coil 14 inductively couples with the susceptor causing the susceptor to be heated. The susceptor 16 provides a uniform heat to nanofiber mats or other material to be processed lying flat on the surface and causes them to be uniformly heated.

FIG. 2A schematically depicts another embodiment of the invention wherein the susceptor 18, which can be of any shape, is a hollow cylinder. The interior diameter of this susceptor is sufficient to accommodate a plurality of polymer nanofiber mats or a volume of material to be processed, as shown in FIGS. 2B and 2C. The cylindrical susceptor 18 provides a uniform heat to samples that do not lie flat and causes them to be uniformly heated.

FIG. 3 shows another embodiment of the invention, in which conventional furnace elements 24 surrounding part of the quartz tube are used to pre-heat process gases to a temperature that may be different from the temperature that the susceptor will heated to. This allows independent control of the temperature of the process gases and the susceptor/sample temperature.

FIG. 4B shows an SEM photo of an electrospun nanofiber mat carbonized and activated using RF induction heating and is illustrative of a product to be produced using the apparatus and method in accordance with the invention. The material in FIG. 4B is indistinguishable in appearance to the material carbonized and activated in a conventional furnace shown in FIG. 4A.

FIG. 5 shows that samples carbonized in a conventional furnace tube at 1000° C. for 1 hr (FIG. 5A) have similar Raman spectra as samples RF carbonized at 1000° C. for 1 hr (FIG. 5B), indicating that the two samples have similar degrees of graphitization.

Those skilled in the art to which this application relates will appreciate that other and further additions, deletions, substitutions and modifications may be made to the described embodiments.

What is claimed is:

1. An apparatus for carbonizing or activating carbon nanofibers, or both carbonizing and activating carbon nanofibers, comprising:
a reactor tube into which a selected atmosphere of process gas can be introduced and that is closed at ends thereof;
a susceptor inside said reactor tube and configured to receive at least one precursor sample; and
at least one radio-frequency coil proximate said reactor tube configured to heat said susceptor.

2. The apparatus as recited in claim 1 wherein said at least one precursor sample is located on said susceptor.

3. The apparatus as recited in claim 1 wherein said at least one precursor sample is located in said susceptor.

4. The apparatus as recited in claim 1 wherein said at least one radio-frequency coil surrounds said reactor tube.

5. The apparatus as recited in claim 1 wherein said reactor tube is closed at said ends thereof by flanges.

6. The apparatus as recited in claim 1 wherein said at least one precursor sample comprises a polyacrylonitrile (PAN).

7. The apparatus as recited in claim 1 wherein said at least one precursor sample is selected from the group consisting of:
a polybenzimidazole (PBI),
a polyimide (PI),
a regenerated cellulose fiber,
a phenol resin,
a cellulose fiber,
a lignin.

8. The apparatus as recited in claim 1 wherein said process gas is heated to a temperature different from that of said susceptor.

9. A method of carbonizing or activating carbon nanofibers, or both carbonizing and activating carbon nanofibers, comprising:
introducing a selected atmosphere of process gas into a reactor tube that is closed at ends thereof;
receiving a sample on or in a susceptor inside said reactor tube; and
heating said susceptor with at least one radio-frequency coil proximate said reactor tube.

10. The method as recited in claim 9 wherein said receiving comprises receiving said at least one precursor sample on said susceptor.

11. The method as recited in claim 9 wherein said receiving comprises receiving said at least one precursor sample in said susceptor.

12. The method as recited in claim 9 wherein said at least one radio-frequency coil surrounds said reactor tube.

13. The method as recited in claim 9 wherein said reactor tube is closed at said ends thereof by flanges.

14. The method as recited in claim 9 wherein said at least one precursor sample comprises a polyacrylonitrile (PAN).

15. The method as recited in claim 9 wherein said at least one precursor sample is selected from the group consisting of:
a polybenzimidazole (PBI),
a polyimide (PI),
a regenerated cellulose fiber,
a phenol resin,
a cellulose fiber,
a lignin.

16. The method as recited in claim 9 wherein said process gas is heated to a temperature different from that of said susceptor.
